(19) United States
(12) Patent Application Publication
(10) Pub. No.: US 2026/0283187 A1
(43) Pub. Date: Sep. 24, 2026

(54) MOLD FOR INSTANT PRODUCTION OF POPSICLES

(71) Applicant: MARINO ARPINO, São Paulo (BR)

(72) Inventor: MARINO ARPINO, São Paulo (BR)

(21) Appl. No.: 19/574,103

(22) Filed: Mar. 20, 2026

(30) Foreign Application Priority Data
Mar. 20, 2025 (BR) 1020250053721

(51) Int. Cl. A23G 9/26; A23G 9/22

(52) U.S. Cl. CPC A23G 9/26; A23G 9/221

(57) ABSTRACT

The present invention refers to a mold for the instant production of popsicles, said mold being formed by two symmetrical parts, each comprising one or more cavities to be filled with the mixture to be frozen, as well as by one or more horizontal channels that function as an evaporator of a refrigeration system, operating in the vapor compression cycle, through which the primary refrigerant fluid circulates, and in which at least part of the wall of the horizontal channels forms the wall of the mold cavity.

### FIELD OF INVENTION

The present invention refers to the field of food products, particularly to the ice cream sector and more particularly to the production of popsicles.

### BACKGROUND

Existing equipment to produce popsicles requires stamped molds which, after being filled with the fluid product, are immersed in a low-temperature liquid (around −30° C. to −35° C.) for freezing. Once frozen, the popsicles adhere to the mold wall, so it is necessary to detach them for removal and subsequent packaging. In order to do so, the molds are subjected to jets or immersion baths of heated water (or another heated fluid), which melt a thin layer of the product in contact with the mold wall.

Patent BR102018012612-1 B1 describes an equipment designed to produce popsicles on an industrial scale. FIG. 1 represents this apparatus, wherein the elements associated with the supply of heated fluid can be observed, comprising a pump 31, a heated fluid tank 33 provided with fluid heating elements (not illustrated) and several pipes, as well as the elements associated with the freezing fluid (in this machine the heated fluid is the same as the freezing fluid, therefore not using water for this purpose), comprising the tank 38 which receives this cooled fluid by a cooling set consisting of a refrigeration compressor, condenser and heat exchanger (not shown in the figure) in order to maintain the temperature of the freezing fluid at −30° C. or lower.

The above equipment has a toroidal freezing channel 1 with a distribution duct 4 at its bottom, provided with a plurality of holes directing jets of pressurized freezing fluid against the molds positioned above said channel. The fluid level is controlled by a pouring spot 5×× where the fluid overflows into a second channel 5 that functions as a reservoir and communicates with the cooling set through a pipe.

This is a complex apparatus, comprising pumps, agitators, fluid level sensors, valves, etc., which requires non-corrosive intermediate freezing fluids that maintain their flow properties at low temperatures, and it is not suitable for artisanal versions. Furthermore, the freezing time for popsicles is relatively long.

Said freezing time is a function of the heat transfer between the popsicle mass and the freezing fluid through the mold wall, where such transfer depends on the thermal conductivity of the material and the thickness of the mold wall. This thickness is related to the degree of corrosion of the material by the freezing fluid: in systems traditionally used in the industry, this fluid is calcium chloride. As this secondary fluid is extremely corrosive, the mold walls in such systems have a thickness of 0.8 mm. Given that the thermal conductivity of stainless steel is only 16 W/m. K, the resulting freezing time for the popsicles is around 12 minutes.

In the system that is object of patent BR102018012612-1 B1, calcium chloride was replaced by a 60% aqueous solution of potassium formate, which does not attack stainless steel, allowing a mold wall thickness of 0.5 mm. Such reduced thickness, combined with the use of a temperature of −35° C., allowed the freezing time to be reduced to 5.5 minutes.

### OBJECTIVES OF THE INVENTION

In view of the previously mentioned, the present invention aims to provide equipment capable of reducing production time to 2 minutes or less.

Another objective of the proposed invention is to provide equipment that has a minimum of moving parts.

Yet another objective of the invention is to provide an equipment capable of producing popsicles in a wide variety of shapes that are currently not achievable by state-of-the-art equipment.

Another objective of the invention is to provide an equipment that can produce aerated popsicles of the MEGA® and MAGNUM® type without the use of costly freezing tunnels. Such possibility allows small manufacturers to have access to what is currently a privilege only for large industries, since the profit margin of such popsicles is quite high.

Another objective of the invention is to provide equipment that reduces the space occupied by the equipment to about ⅓ of the space occupied by state-of-the-art equipment.

Another objective of the invention is to provide equipment that allows the production of one popsicle at a time, in front of the customer, in a short period of time, to serve the fast-food market, in the style of soft ice creams already sold by such groups.

Another objective of the invention is to provide a super-compact, simple and easy-to-operate equipment, thus serving small manufacturers.

Finally, another objective of the invention is to provide equipment that offers a reduction in production costs of approximately 70%, assuring a higher profit margin for manufacturers, when compared to state-of-the-art equipment.

### BRIEF DESCRIPTION OF THE INVENTION

The above objectives, as well as others, are achieved by the invention by providing an equipment comprising a two-part mold, consisting of two symmetrical halves, each half comprising one or more cavities to be filled by the mixture to be frozen, as well as one or more horizontal channels that function as an evaporator of a refrigeration system operating in the vapor compression cycle (Kelvin cycle) where the primary refrigerant fluid circulates, wherein at least part of the wall of said channel forms the wall of said mold cavity.

In one embodiment, a seal is provided between the symmetrical halves of the mold, where each half-cavity (of the popsicle) of the mold has a flexible seal (typically silicone or special non-toxic rubber), as detailed in the exploded view in FIG. 3, which is compressed against the seal of the opposite cavity when the two halves of the mold are closed. It prevents leaks of the popsicle mixture before freezing begins and accommodates any expansion during the process. Such seal may be omitted if the two halves of the mold are perfectly flat and have a fine finish, which can be achieved by final grinding of the surface.

According to another embodiment of the invention, the mold is made of metal or metal alloy, such as copper or other alloys with high thermal conductivity.

According to another embodiment of the invention, the mold is made of stainless steel, such as SAE 630(17-4 PH), SAE 316 or SAE 304.

According to another embodiment of the invention, the inner surface of said mold is made non-stick by means of specific treatment, comprising, among others, laser irradiation polishing.

According to another embodiment of the invention, the mold can be manufactured from thermosetting plastic.

According to another embodiment of the invention, the mold is produced using the additive manufacturing technique (3D printing), such as DMLS or similar, in the case of a metal mold.

According to another embodiment of the invention, the plastic mold can be produced using the molding technique under pressure, where a thermosetting resin is injected, to enclose copper tubes where the refrigerant fluid circulates.

According to another embodiment of the invention, the mold can be produced using the 3D additive manufacturing technique using laser-polymerizable resin or other UV light sources.

### DESCRIPTION OF THE FIGURES

The invention will be better understood by means of the description of exemplary, not limiting, embodiments of the figures to which it refers, wherein:

FIG. 1 illustrates the two-part mold opened at an angle to remove the frozen popsicles.

FIG. 2 is a transparent view of the outer face of half of the mold, showing one of the possible arrangements of the freezing fluid circulation channels.

FIG. 3 illustrates one half of the mold, showing the inner face where the cavities are provided.

FIG. 4 is a cross-section of half of the mold.

FIG. 5 shows a second way of approximate and separate the mold halves, by means of translational movement instead of angular movement.

FIG. 6 shows, schematically, the refrigeration circuit as used in the invention.

FIG. 7 shows the same circuit when used in the mold release function by heating the molds.

### DETAILED DESCRIPTION OF THE INVENTION

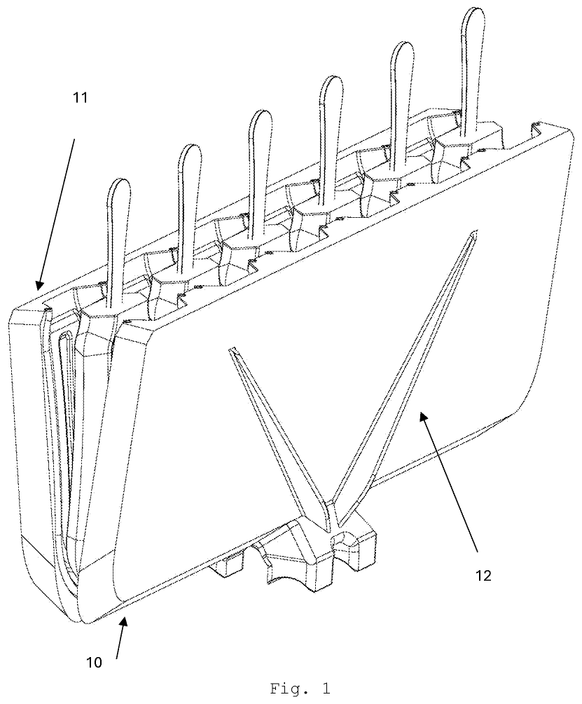

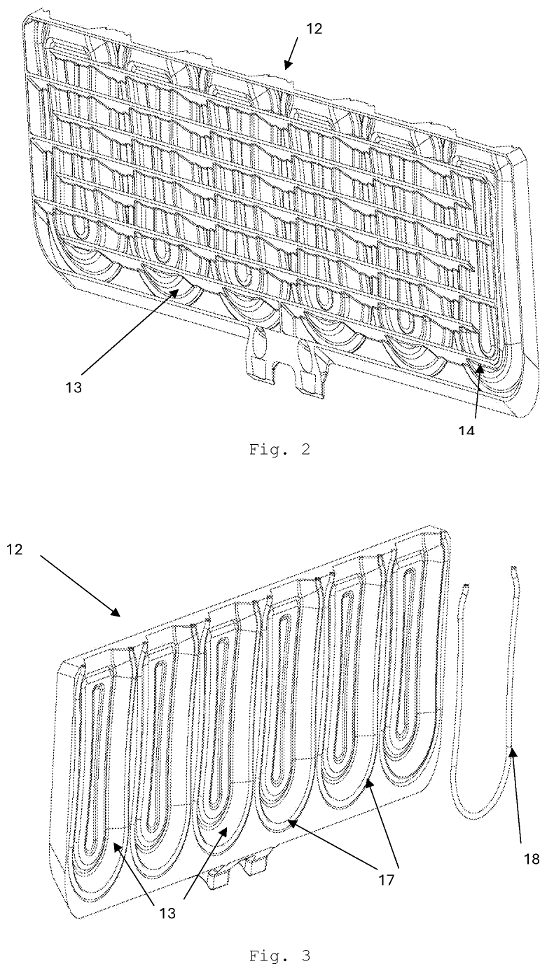

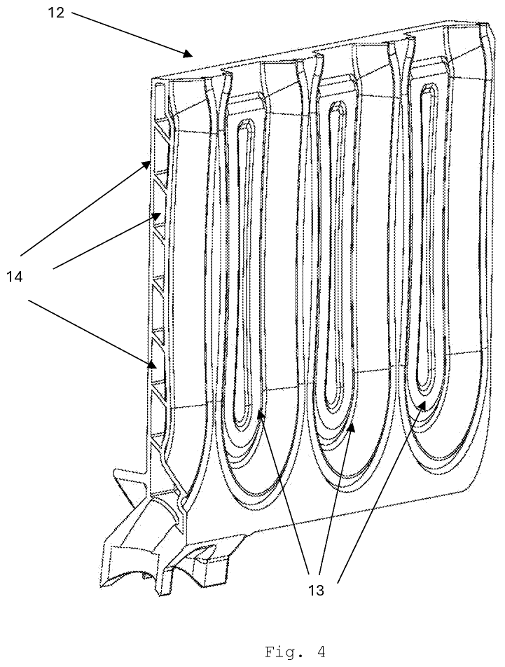

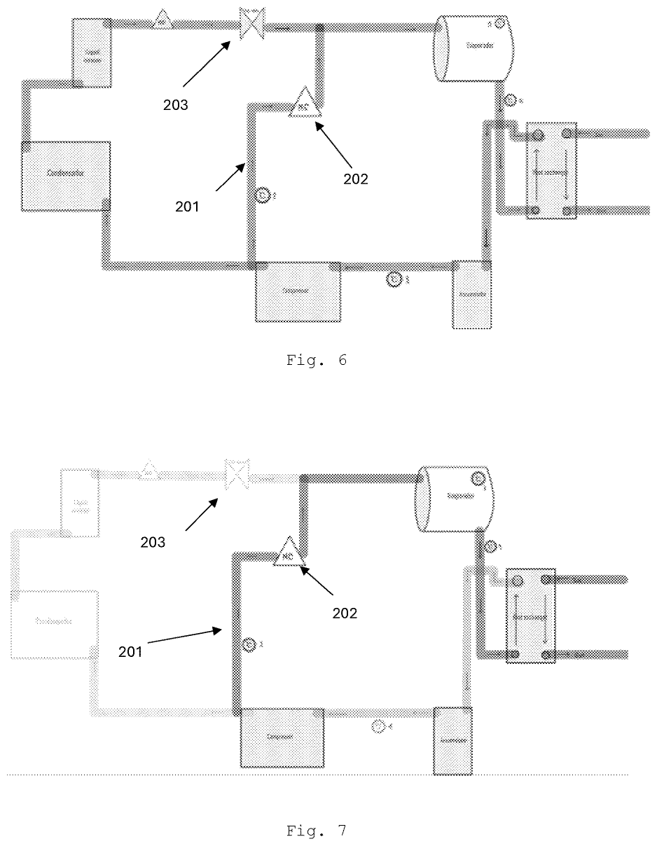

Referring to FIGS. 1 and 2, the mold 10 is formed by two symmetrical and complementary halves 11 and 12, articulated together in their lower region, which, when juxtaposed by closing, create cavities that are filled with the mass to be frozen. Each half of the mold comprises, in addition to the semi-cavities 13, a set of juxtaposed horizontal channels 14 forming a vertical plane as detailed in FIG. 4. The channels of this plane form the evaporator element of a modified vapor compression cycle (or Kelvin cycle) refrigeration circuit, illustrated in FIG. 6, which will be detailed later. There is the possibility of such multi-channels 14, for refrigerant circulation, having their inner walls provided with small protrusions to increase turbulence/heat exchange. There is a provision for a seal between the symmetrical halves 11 and 12 of the mold 10, where each popsicle half-cavity 11 or 12 of the mold 10 has a flexible seal 18 (typically silicone or special non-toxic rubber), as detailed in the exploded view in FIG. 3, which is compressed against the seal of the opposite cavity 17 when the two halves 11 and 12 of the mold 10 are closed. It prevents leaks of the popsicle mixture before freezing begins and accommodates any expansion during the process. Such seal may be omitted if the two halves 11 and 12 of the mold 10 are perfectly flat and have a fine finish, which can be achieved by final grinding of the surface.

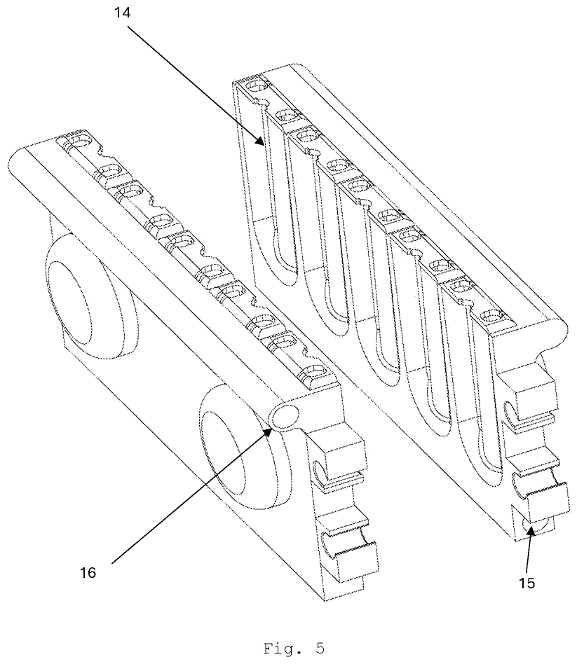

The primary refrigerant fluid, which can be a Freon-type gas or equivalent, is introduced through duct 15 and, after passing through the set of channels 14, exits through the duct 16 to return to the refrigeration circuit, as shown in FIG. 5.

The freezing of the popsicle mass occurs through direct heat exchange between the primary refrigerant and the popsicle mixture to be frozen, thus eliminating the secondary fluid used in conventional systems. It allows the freezing time to be reduced to about 1 to 3 minutes, making it possible to prepare the popsicle in front of the customer.

It is known that, in both conventional systems and that of the invention, the freezing of the mass is progressive, where initially the surface of the popsicle (the one in contact with the mold) freezes, progressing by conduction to its interior, where the stick is located. Accordingly, the freezing time can be reduced by modifying the geometry of the popsicle, namely, reducing its thickness and increasing its external surface area. Thus, for example, reducing the thickness from 15-19 mm to 12 mm, associated with a width of 54 mm, and increasing the length from 100 mm to 130 mm, provides a freezing time of 2 minutes, while maintaining the total volume of the popsicle.

As can be seen in FIG. 4, the structure of each semi-mold comprises internal channels 14, which cannot be formed by simple manufacturing processes such as, for example, stamping or machining. In the present invention, the molds are formed by means of so-called 3D printing based on additive manufacturing technology, particularly SLS (Selective Laser Sintering), using the sintering of metal powders, such as stainless steel, aluminum and copper, by means of a high-power laser. It is known that there is the possibility of constructing this part by additive manufacturing called “Binder Jet”, which does not use a laser, but also follows the method of adding layers of metal, bonded together by means of an adhesive resin (in the laser process the layers are fused to each other by the action of the laser beam) and subsequently fused together in a high-temperature furnace.

As mentioned above, the low conductivity of stainless-steel limits the time savings in freezing popsicles. Thus, the use of molds made of aluminum or copper is advantageous from the point of view of reducing this time but presents the disadvantage of not being able to get in contact with food materials. To solve this problem, a layer of chromium-nickel, polytetrafluoroethylene (PTFE-TEFLON) or other suitable materials should be applied to the cavities, as these get in contact with the food, in this case, the popsicle mass.

Once freezing has occurred, the frozen popsicles must be removed from the mold by mutual separation of the half-molds through an angled opening, as illustrated in FIG. 1, or by translational movement, as illustrated in FIG. 5. In addition to this mechanical separation, it is necessary to prevent the popsicle mass from adhering to the walls of the cavities. In other words, it is necessary to reduce the wettability of the surfaces in contact with the mass, which implies making these surfaces hydrophobic, which can be done by laser treatment of such surfaces.

In a preferred embodiment of the invention, polishing is a process used especially to make the surface hydrophobic, in addition to reduce the surface roughness. This good result is achieved with higher power and speed polishing, as well as a high track overlap rate (90%), which allows for a more homogeneous surface. It should be noted that in tests performed, the speed of the laser polishing process was 100 mm/s at a power of 800 W, resulting in better surface conditions of the product.

In addition to laser polishing, cavity surfaces can be made hydrophobic by means of other known processes, such as, for example, PTFE coating as described, for example, in U.S. Pat. No. 6,745,595. However, PTFE has the disadvantage of wearing out quickly, requiring periodic reapplication.

The need to make the cavity surfaces hydrophobic is a function of the temperature of the freezing fluid. Thus, if R-404A is used as the primary refrigerant, the temperature in channels 14 will be around-40° C., which requires hydrophobicity of such surfaces. However, such need disappears in temperatures below −70° C. Therefore, the use of liquid nitrogen eliminates the need for any surface treatment of the cavities, as it enters the mold at −196° C. in liquid form and preferably exits the mold evaporated, at the same temperature or slightly warmer.

The same additive manufacturing technology (3D printing) can be employed in the manufacture of molds in synthetic resin, which are used in machines for occasional use and/or production in small quantities, where the plastic mold solution may be sufficient. Even if the freezing time is longer than with metal molds, certain resins have the advantage of not requiring special coatings for contact with food.

In addition to the angular movement for opening and closing the mold, illustrated in FIG. 1, the mold halves can be juxtaposed or separated linearly, according to a translational movement. FIG. 5 exemplifies this embodiment of the invention, noting that, in this case, the ends of the mold are provided with fittings through which guide bars pass, along which the movement of the mold halves takes place.

FIG. 6 is a schematic of the refrigeration circuit preferably adopted in the invention. This is the vapor compression cycle, also known as the Kelvin cycle, whose main components are the compressor, the condenser, and the evaporator. As illustrated, the refrigerant enters the compressor in vapor form, with low pressure and low temperature, and exits the compressor with high pressure and high temperature. This high-pressure vapor then passes through the condenser, where it is transformed into liquid. Such liquid, in turn, passes through the expansion valve, where the pressure drops abruptly, resulting in a mixture of liquid and vapor. Such mixture is introduced into the evaporator, which, in this case, is the set of ducts provided in the mold.

Upon completion of evaporation, the refrigerant fluid removes heat from the popsicle mass, reducing its temperature. When leaving evaporator, the refrigerant vapor returns to the compressor, where the cycle restarts.

In the invention arrangement, the basic circuit is modified by introducing duct 201 which connects the compressor outlet to the evaporator inlet and to valves 202 and 203. Such modification allows the same circuit to be used for demolding the popsicles. As shown in FIG. 7, in this function, the valve 203 is closed, blocking the passage of high-pressure fluid through the condenser and the expansion valve. In turn, the valve 202 is opened, so that the vapor, compressed at high pressure and high temperature, is diverted directly to the mold (evaporator). Such compressed vapor is at a temperature of about 100° C., causing demolding to occur after about 10 seconds. Once the temperature of the vapor exiting, the mold is higher than in the freezing mold (as in FIG. 6), it is necessary to protect the compressor against overheating, which should not exceed 100° C. Pre-cooling of the vapor before it enters the compressor is provided by circulating water in the heat exchanger, so that the vapor enters the compressor at a temperature below 100° C. It should be noted that the use of hot gas for demolding, as described above, eliminates the need to make the surface of mold cavities hydrophobic; however, the production cycle time is increased, and the system efficiency is impaired by the cyclical heating and cooling of the metal mass.

Although the invention has been described with reference to some specific embodiments, it is understood that modifications may be introduced by those skilled in the art, provided that they remain within the spirit and scope of the invention, which is defined by the appended claims.

1. A mold for the instant production of popsicles, comprising a two-part mold, consisting of two symmetrical halves, each half comprising one or more cavities to be filled by the mixture to be frozen, wherein a set of one or more horizontal channels is provided in which a primary refrigerant fluid circulates, wherein part of the wall of said horizontal channels forms the wall of said one or more cavities.

2. The mold according to claim 1, wherein said channels of the refrigeration system have their inner walls provided with small protrusions, increasing turbulence/heat exchange.

3. The mold according to claim 1, wherein the mold is made with recesses around the cavities that accommodate elastomeric profiles to prevent leakage of the frozen mixture and also to accommodate its expansion during the freezing process.

4. The mold according to claim 1, wherein the mold is produced using the additive manufacturing technique by 3D printing.

5. The mold according to claim 2, wherein the mold is manufactured from metal or metal alloy.

6. The mold according to claim 3, wherein the mold is manufactured from stainless steel 630 (17-4 PH).

7. The mold according to claim 2, wherein the mold 10 is manufactured from synthetic resin.

8. The mold according to claim 1, wherein the inner surface of said one or more cavities is made non-stick by means of a specific treatment.

9. The mold according to claim 8, wherein said specific treatment comprises polishing by laser irradiation.

10. The mold according to claim 8, wherein said specific treatment comprises the application of a PTFE layer.

11. The mold according to claim 1, wherein the mold is produced in plastic material using a molding technique under pressure, where a thermosetting resin is injected to envelop copper tubes where a refrigerant fluid circulates.

12. The mold according to claim 1, wherein the opening and closing of the mold are provided by the angular movement of the mold halves.

13. The mold according to claim 1, wherein the opening and closing of the mold are provided by linear movement, including translation, of the mold halves.

14. The mold according to claim 1, wherein the demolding is provided by heating resulting from the passage, through at least one channel, of high-pressure, high-temperature steam supplied by the compressor of a Kelvin refrigeration cycle.
